(19) United States
(12) Patent Application Publication
(10) Pub. No.: US 2017/0373616 A1
(43) Pub. Date: Dec. 28, 2017

(54) Motor, Activation Control Method for the Motor, and Fan including the Motor

(71) Applicant: Sunonwealth Electric Machine Industry Co., Ltd., Kaohsiung City (TW)

(72) Inventors: Alex Horng, Kaohsiung City (TW); Chih-Hsiang Chiu, Kaohsiung City (TW)

(21) Appl. No.: 15/613,341

(22) Filed: Jun. 5, 2017

(30) Foreign Application Priority Data
Jun. 28, 2016 (TW) 105120353

(51) Int. Cl. H02P 6/15; G05B 19/042; H02J 13/00; H05B 37/02

(52) U.S. Cl. CPC H02P 6/157; H05B 37/0281; G05B 19/0423; H02J 13/0024

(57) ABSTRACT

A motor includes a stator coil, a rotor and a driving unit. The stator coil is configured to be electrified to generate a magnetic force. The rotor is rotatably coupled with the stator coil and includes a magnetic member facing the stator coil. The driving unit is electrically connected to the stator coil and outputs a driving signal to the stator coil. An electrical characteristic value of the driving signal increases in a gradual manner. The rotor outputs a motive power that is gradually increased during a process the rotor rotates from an electric angle back to a same electric angle. In addition, an activation control method for the motor and a fan are also disclosed.

### CROSS REFERENCE TO RELATED APPLICATIONS

The application claims the benefit of Taiwan application serial No. 105120353, filed on Jun. 28, 2016, and the entire contents of which are incorporated herein by reference.

### BACKGROUND OF THE INVENTION

### 1. Field of the Invention

The present invention generally relates to a motor, an activation control method for the motor, and a fan including the motor and, more particularly, to a motor which can automatically adjust the activation force according to different loads, an activation control method for the motor, and a fan including the motor.

### 2. Description of the Related Art

Motors can convert the electricity into motive power to be outputted. The motive power can drive a load, constructing various electric devices. As an example of a fan, the fan can use a motor that converts the electricity into motive power to be outputted. Thus, the motor is able to drive the blades to rotate, thereby generating airflows for air circulation purposes or cooling purposes. The fan may be a wall fan, a ceiling fan, a blower or an axial-flow fan.

During the activation process of the conventional fan, a general driver can output a driving signal to the coil of the motor, so as to drive the rotor of the motor to rotate. As the motor is used in different electric devices, the loads (such as blades) to be driven by the general driver are also different. In addition, the motive power outputted by the rotor of the motor must match the load. If the motive power is too large, the electric device tends to vibrate. If the motive power is too small, the load cannot be driven.

However, the activation control of the conventional motor is suitable only for a constant load as it is not able to adjust the activation force based on different weights. As a result, the electric device may highly likely encounter problems including repeated angle searching, long activation time or activation failure due to the improper motive power or dead angle of the motor.

In light of this, it is necessary to overcome the disadvantages of the prior art for practical use, improving the utility thereof.

### SUMMARY OF THE INVENTION

It is therefore an objective of this invention to provide a motor which can gradually increase the outputted motive power within an electric) angle during the activation process, thereby smoothly activating different loads that have different masses.

It is another objective of this invention to provide a motor control method which can control the motor to gradually increase the outputted motive power within an electric angle during the activation process, thereby smoothly activating different loads that have different masses.

It is a further objective of this invention to provide a fan which can gradually increase the outputted motive power within an electric angle during the activation process, thereby smoothly activating different blades that have different masses.

In an aspect, a motor includes a stator coil, a rotor and a driving unit. The stator coil is configured to be electrified to generate a magnetic force. The rotor is rotatably coupled with the stator coil and includes a magnetic member facing the stator coil. The driving unit is electrically connected to the stator coil and outputs a driving signal to the stator coil. An electrical characteristic value of the driving signal increases in a gradual manner. The rotor outputs a motive power that is gradually increased during a process the rotor rotates from an electric angle back to a same electric angle.

In another aspect, a fan includes a stator coil, a rotor and a driving unit. The stator coil is configured to be electrified to generate a magnetic force. The rotor is rotatably coupled with the stator coil and includes a magnetic member and a plurality of blades. The magnetic member faces the stator coil. The driving unit is electrically connected to the stator coil and outputs a driving signal to the stator coil. An electrical characteristic value of the driving signal increases in a gradual manner. The rotor outputs a motive power that is gradually increased during a process the rotor rotates from an electric angle back to a same electric angle.

In a further aspect, an activation control method for a motor is applied to a driving unit which controls the operation of the motor. The activation control method includes outputting a driving signal to a stator coil of the motor by the driving unit. An electrical characteristic value of the driving signal increases in a gradual manner. A rotor of the motor outputs a motive power that is gradually increased during a process the rotor rotates from an electric angle back to a same electric angle.

During the process the rotor rotates from the electric angle back to the same electric angle, an electrical characteristic value of the driving signal may increase from an initial value to a target value. The electrical characteristic value of the driving signal may be a multiple of a predetermined electrical value and an adjustment ratio. The adjustment ratio may be a characteristic curve with a gradually increasing pattern over time. The characteristic curve may include a start point and an end point along a time axis. A magnitude of the characteristic curve at the end point is larger than a magnitude of the characteristic curve at the start point. The characteristic curve may be in a linear or non-linear shape. The adjustment ratio may be between 30% and n*100% where n is a positive integer. Based on this, since the power that is outputted from the driving signal to the stator coil increases in a gradual manner, the outputted motive power of the rotor may gradually increase during the process the rotor rotates from the electric angle back to the same electric angle. Thus, the rotor can be started smoothly.

The driving unit may be electrically connected to a control unit. The control unit may output a control signal to the driving unit. The driving unit generates the driving signal based on the control signal. The control signal is a pulse signal having a gradually-increasing duty cycle, magnitude or frequency. A measurement unit may be electrically connected between the control unit and the driving unit and is adapted to detect an output voltage of the driving unit. The control unit may include an application-specific integrated circuit (ASIC), a microcontroller unit (MCU) or a digital signal processor (DSP). Based on this, the electrical characteristic value of the driving signal may gradually increase from the initial value to the target value under the gradual increase of the duty cycle, the amplitude or the frequency as controlled by the control signal. Accordingly, the outputted motive power of the rotor may gradually increase during the process the rotor rotates from an electric angle back to a same electric angle. Thus, the start angle of the rotor can be smoothly found and the rotor can be started with a proper force, completing the activation process of the motor.

In the motor, the fan having the motor, and the activation control method for the motor mentioned above, the outputted motive power of the rotor may gradually increase during the process the rotor rotates from the electric angle back to the same electric angle. Therefore, the start angle of the rotor can be smoothly found and the loads having different masses (such as blades) can be driven to rotate under proper motive power, completing the activation process of different loads. This can achieve the advantages of easy searching of the start angle, the flexible use with different loads having different masses, and smooth activation of the motor. Furthermore, this can also be used in various motor control circuits such as a fan activation control circuit. Advantageously, smooth start of the motor can be achieved and the complexity in controlling the activation process of the motor can be reduced.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a block diagram of a fan having a motor according to an embodiment of the invention.

FIG. 2 is a cross sectional view of the fan according to the embodiment of the invention.

FIG. 3 shows a characteristic curve diagram of the electrical current of a coil of the motor.

FIG. 4 shows a flowchart of an activation control method for the motor according to the invention.

### DETAILED DESCRIPTION OF THE INVENTION

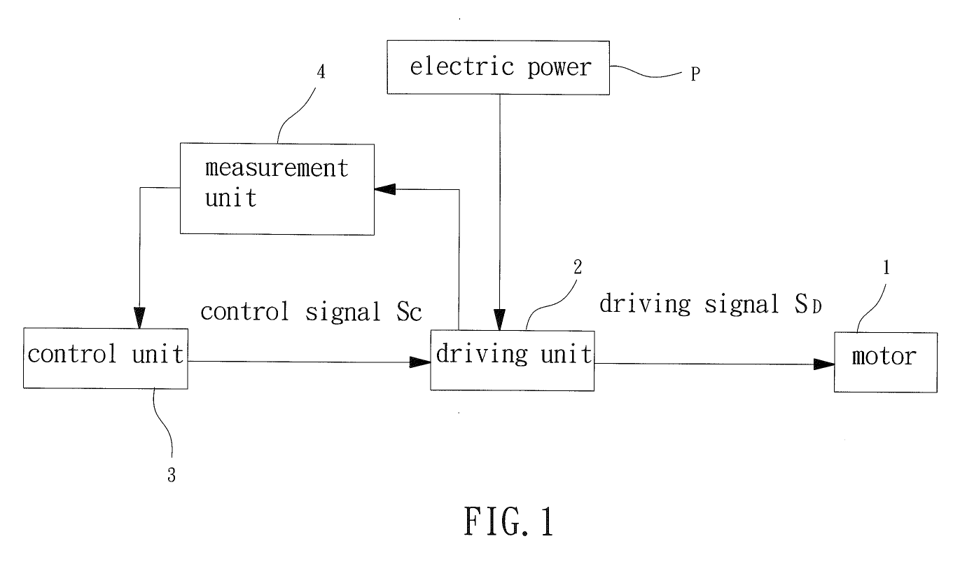

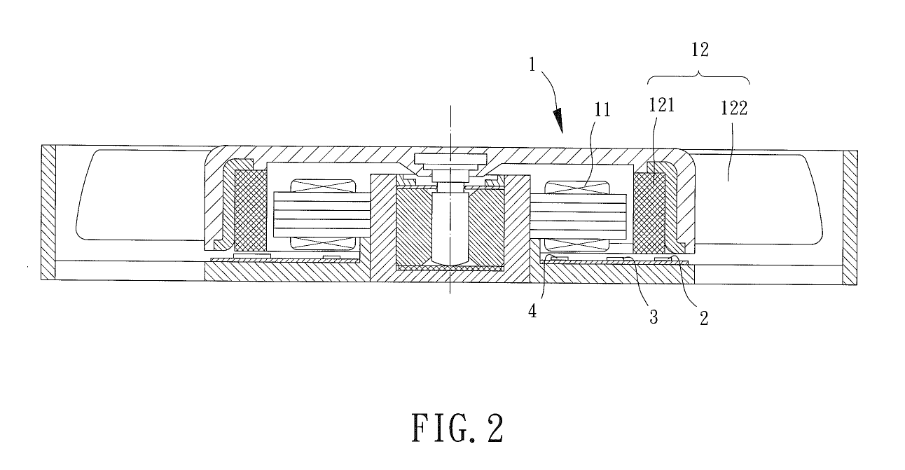

FIG. 1 shows a block diagram of a fan having a motor 1 according to an embodiment of the invention. FIG. 2 shows a cross sectional view of the fan. The motor 1 can be used as a source of motive power for the fan or other electric devices. As an example of the fan, the fan includes the motor 1 and a driving unit 2 electrically connected to a stator coil 11 of the motor 1. The driving unit 2 outputs a driving signal S_{D} to the stator coil 11 of the motor 1. The electrical characteristic value of the driving signal S_{D} (such as a voltage, a current, or power) may increase in a gradual manner, so that the outputted motive power of the motor 1 can gradually increase during which the rotor 12 of the motor 1 rotates from an electric angle back to the same electric angle.

In this embodiment, the motor 1 may be a motor suitable for use in any type of the fan, such as a wall fan, a ceiling fan or an axial-flow fan. Referring to FIG. 2, the motor 1 includes at least one stator coil 11 and a rotor 12. The stator coil 11 may be the coil of a single-phased or three-phased motor and is used to generate a magnetic force. The rotor 12 is rotatably coupled with the stator coil 11 and includes a magnetic member 121 facing the stator coil 11. The magnetic member 121 is driven by the magnetic force of the stator coil 11 to drive the rotor 12 to rotate. The rotor 12 may have a plurality of blades 122 in order to form a fan. The blades 122 may rotate to generate air currents, and the detail thereof is not described herein as it can be readily appreciated by the person having ordinary skill in the art.

Referring to FIGS. 1 and 2, the driving unit 2 may be a bridge circuit such as a full-bridge or a half-bridge circuit module. The driving unit 2 is electrically connected to an electric power P and the stator coil 11 of the motor 1, so as to output the driving signal S_{D} to the stator coil 11 of the motor 1. Thus, the electric power P can provide the motor 1 with the required power. The driving unit 2 may be integrated in the circuit board of the motor 1 and becomes a part of the internal structure of the motor 1 to reduce the overall volume. However, this is not used to limit the invention.

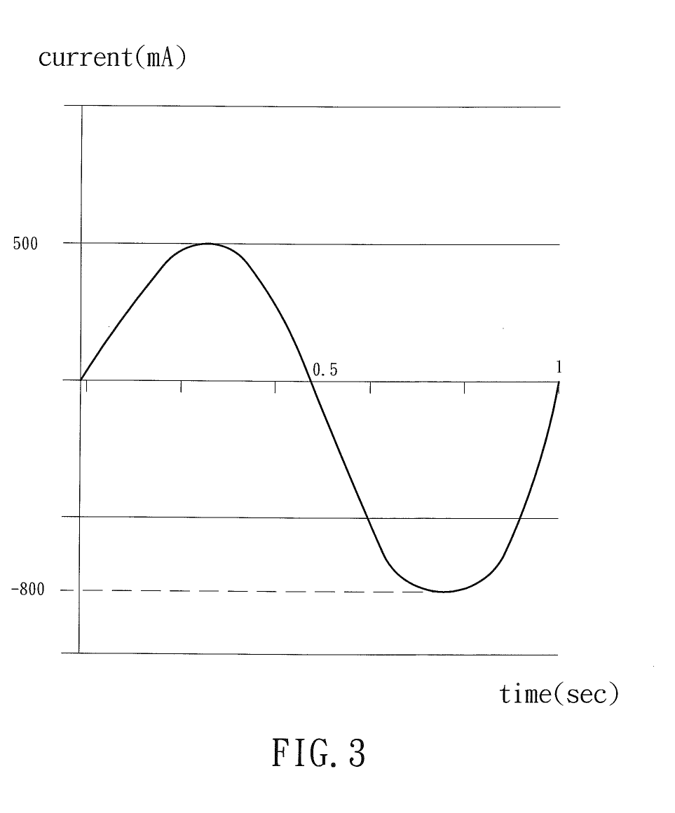

When the driving unit 2 is to start the rotation of the rotor 12, the driving unit 2 outputs the driving signal S_{D} to the stator coil 11. During the process the rotor 12 rotates from an electric angle back to the same electric angle (such as the rotor 12 rotates one complete cycle of 360 degrees from 0 degree back to 0 degree), the electrical characteristic value of the driving signal S_{D} (such as the current, voltage or power value) may gradually increase from an initial value to a target value over time. For example, the electrical characteristic value of the driving signal S_{D} is a multiple of a predetermined electrical value and an adjustment ratio. The range of the adjustment ratio may be between 30% and n*100% wherein n is a positive integer. The adjustment ratio may be a characteristic curve with a gradually increasing pattern. For example, the characteristic curve may have two end points including a start point and an end point along a time axis. The magnitude of the characteristic curve at the end point is larger than the magnitude of the characteristic curve at the start point. The characteristic curve may be in a continuous-time or discrete-time function. As an example of the continuous-time function, the characteristic curve may be in a linear or non-linear shape, such as a straight-line shape, a curved shape, or even a non-straight line shape having one or more bending points between the start point and the end point thereof. In the case of the straight line, if the stator coil 11 of the motor 1 is the coil of a three-phased motor, the electrical current of any one of the three phases may have a sinusoidal waveform. The peak value of the sinusoidal waveform may increase over time as shown in FIG. 3. The increment may be adjusted according to the requirement and is not limited herein. Thus, since the electrical characteristic value (which is outputted to the stator coil 11 from the driving signal S_{D}) increases in a gradual manner over time, the outputted motive power of the rotor 12 may increase gradually during the process the rotor 12 rotates from an electric angle back to the same electric angle. Accordingly, the rotor 12 can be smoothly started.

Referring to FIGS. 1 and 2, the driving unit 2 may also electrically connect to a control unit 3. The control unit 3 may output a control signal Sc to the driving unit 2 so that the driving unit 2 is able to generate the driving signal S_{D} based on the electrical characteristic value of the control signal Sc. This permits the electrical characteristic value of the control signal Sc to gradually increase from the initial value to the target value. In this embodiment, the control unit 3 is a device capable of controlling a motor, such as a microcontroller unit (MCU), a digital signal processor (DSP), or an application-specific integrated circuit (ASIC). The control unit 3 may be integrated on a circuit board of the motor 1. The control unit 3 may store a control logic (such as hardware circuits or software programs) and the required data in advance for generating the control signal Sc. The control signal Sc is a pulse signal whose duty cycle, amplitude or frequency may be used to represent the adjustment ratio. For example, the duty cycle, the amplitude or the frequency may increase over time, such as in a gradual manner with even or uneven increments. The increase of the duty cycle, the amplitude or the frequency may be proportional to the increase of the magnitude of the driving signal S_{D}, permitting the electrical characteristic value of the driving signal S_{D} to gradually increase from the initial value to the target value.

Referring to FIGS. 1 and 2 again, a measurement unit 4 may be electrically connected between the control unit 3 and the driving unit 2. The measurement unit 4 detects the output voltage of the driving unit 2. Thus, the control unit 3 can adjust the duty cycle, the amplitude or the frequency according to the detected result. The control unit 3 can also automatically adjust the duty cycle, the amplitude or the frequency according to a lookup table or a mathematic equation.

Based on this, the electrical characteristic value of the driving signal S_{D} may gradually increase from the initial value to the target value under the gradual increase of the duty cycle, the amplitude or the frequency as controlled by the control signal Sc. As a result, the rotor 12 can gradually increase its outputted motive power over time during the process the rotor 12 rotates from an electric angle back to the same electric angle. Thus, the start angle of the rotor 12 can be found, driving the rotor 12 to rotate under a proper force. Accordingly, the activation of the fan is achieved.

The invention further discloses an example of a motor control method according to another embodiment. The motor control method can be applied to the driving unit 2 which drives the motor 1 to rotate. The motor control method includes outputting the driving signal S_{D} to the stator coil 11 of the motor 1 by the driving unit 2. The electrical characteristic value of the driving signal S_{D} increases in a gradual manner, such that the outputted motive power of the motor 1 can gradually increase during which the rotor 12 of the motor 1 rotates from an electric angle back to the same electric angle. The embodiment of the activation control method for the fan is described above, and therefore is not described herein again. In the following, the use of the activation control method for the motor is described as a non-limiting example.

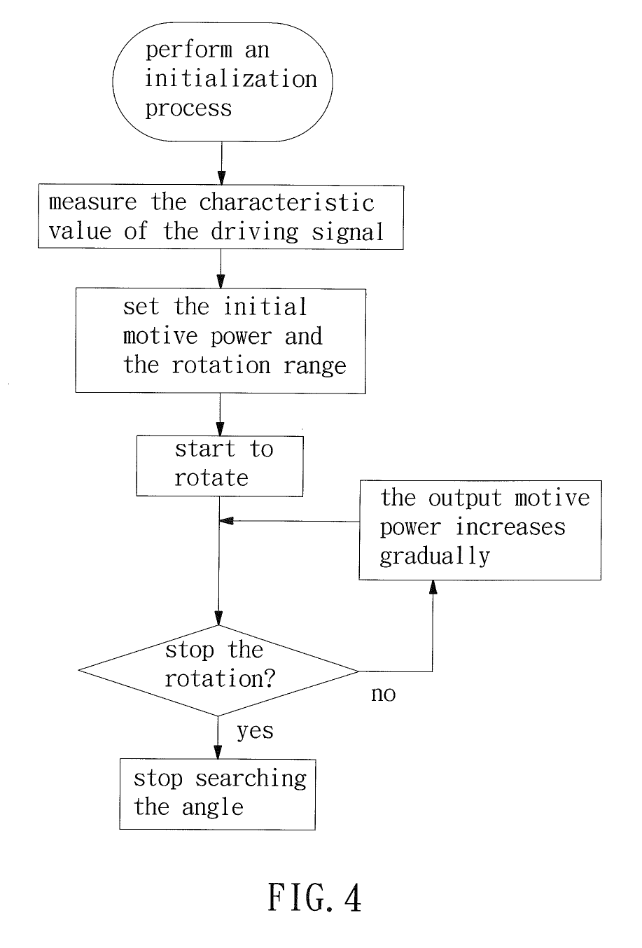

For example, FIG. 4 shows a flowchart of the activation control method for the fan according to the invention. In practical use, the activation control method can be used to activate a load with a certain mass, such as blades of 100-500 gram. However, this is not used to limit the invention. As an example of a fan, an initialization process may be performed to set the initial condition of the fan. Then, the electrical characteristic value of the driving signal S_{D} may be measured by the measurement unit 4 in order for the control unit 3 to set the values, such as the initial power and rotation angle. The control unit 3 may control the driving unit 2 to output electric power to the stator coil 11 of the motor 1. This can generate a magnetic force and can drive the rotor 12 of the motor 1 to rotate. For example, the rotation of the rotor 12 may start at an electric angle (such as 0 degree), and the rotor 12 may perform an angle searching process. Next, the driving unit 2 (or the control unit 3) may determine whether it is needed to finish the angle searching process according to whether the rotor 12 has rotated to the same electric angle (such as 0 degree), for example. If the determined result is positive, the angle searching process is terminated, continuously driving the rotor 12 to rotate. If the determined result is negative, the electrical characteristic value of the driving signal S_{D} is gradually increased within the range of the electric angle (360 degrees), permitting the generated magnetic force of the stator coil 11 of the motor 1 to gradually increase over the varying electric angle. Accordingly, the outputted motive power of the rotor 12 (such as the rotational speed) is gradually increased over time (from the initial value to the target value). The range of the value may include the loads that the fan is able to drive during the practical use thereof. Therefore, the blades can be smoothly driven to rotate by the gradually-increased motive power. However, this is not used to limit the invention.

Furthermore, the initial stop position of the rotor 12 must be within 360 degree. Therefore, based on the angle searching process, the stator coil 11 of the motor 1 can be used to generate the gradually increased electromagnetic force within the range of the electric angle regardless of the stop angles of the magnetic poles of the rotor and the mass of the load of the motor in actual use. Thus, the outputted motive power of the rotor 12 can increase gradually so that the activation angle of the rotor 12 can be obtained. As a result, the activation process of the motor having different loads can be smoothly completed.

Based on the above, the rotor of the motor according to any of the above embodiments of the invention is able to gradually increase the outputted motive power during the process the rotor rotates from an electric angle back to the same electric angle. Thus, the activation angle of the rotor can be smoothly found, thus driving the loads (such as the blades) of different masses with proper motive power to complete the activation process of the loads. This can achieve the advantages of easy searching of the start angle, the flexible use with different loads having different masses, and smooth activation of the motor. Furthermore, this can also be used in various motor control circuits, such as a fan activation control circuit. Advantageously, smooth start of the motor can be achieved, and the complexity in controlling the activation process of the motor can be reduced.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A motor comprising:
a stator coil configured to be electrified to generate a magnetic force;
a rotor rotatably coupled with the stator coil and including a magnetic member facing the stator coil; and
a driving unit electrically connected to the stator coil and outputting a driving signal to the stator coil, wherein an electrical characteristic value of the driving signal increases in a gradual manner, and wherein the rotor outputs a motive power that is gradually increased during a process the rotor rotates from an electric angle back to a same electric angle.

2. The motor as claimed in claim 1, wherein the electrical characteristic value of the driving signal increases from an initial value to a target value during the process the rotor rotates from the electric angle back to the same electric angle.

3. The motor as claimed in claim 2, wherein the electrical characteristic value of the driving signal is a multiple of a predetermined electrical value and an adjustment ratio.

4. The motor as claimed in claim 3, wherein the adjustment ratio is a characteristic curve with a gradually increasing pattern over time.

5. The motor as claimed in claim 4, wherein the characteristic curve includes a start point and an end point along a time axis, wherein a magnitude of the characteristic curve at the end point is larger than a magnitude of the characteristic curve at the start point.

6. The motor as claimed in claim 5, wherein the characteristic curve is in a linear shape.

7. The motor as claimed in claim 5, wherein the characteristic curve is in a non-linear shape.

8. The motor as claimed in claim 3, wherein the adjustment ratio is between 30% and n*100% wherein n is a positive integer.

9. The motor as claimed in claim 1, wherein the driving unit is electrically connected to a control unit, wherein the control unit outputs a control signal to the driving unit, and wherein the driving unit generates the driving signal based on the control signal.

10. The motor as claimed in claim 9, wherein the control signal is a pulse signal having a gradually-increasing duty cycle.

11. The motor as claimed in claim 9, wherein the control signal is a pulse signal having a gradually-increasing magnitude.

12. The motor as claimed in claim 9, wherein the control signal is a pulse signal having a gradually-increasing frequency.

13. The motor as claimed in claim 9, wherein a measurement unit is electrically connected between the control unit and the driving unit and detects an output voltage of the driving unit.

14. The motor as claimed in claim 9, wherein the control unit includes an application-specific integrated circuit (ASIC).

15. The motor as claimed in claim 9, wherein the control unit includes a microcontroller unit (MCU) or a digital signal processor (DSP).

16. An activation control method for a motor that is applied to a driving unit which controls the operation of the motor, comprising outputting a driving signal to a stator coil of the motor by the driving unit, wherein an electrical characteristic value of the driving signal increases in a gradual manner, and wherein a rotor of the motor outputs a motive power that is gradually increased during a process the rotor rotates from an electric angle back to a same electric angle.

17. The activation control method for the motor as claimed in claim 16, wherein the electrical characteristic value of the driving signal increases from an initial value to a target value during the process the rotor rotates from the electric angle back to the same electric angle.

18. The activation control method for the motor as claimed in claim 17, wherein the electrical characteristic value of the driving signal is a multiple of a predetermined electrical value and an adjustment ratio.

19. The activation control method for the motor as claimed in claim 18, wherein the adjustment ratio is a characteristic curve with a gradually increasing pattern over time.

20. The activation control method for the motor as claimed in claim 19, wherein the characteristic curve includes a start point and an end point along a time axis, wherein a magnitude of the characteristic curve at the end point is larger than a magnitude of the characteristic curve at the start point.

21. The activation control method for the motor as claimed in claim 20, wherein the characteristic curve is in a linear shape.

22. The activation control method for the motor as claimed in claim 20, wherein the characteristic curve is in a non-linear shape.

23. The activation control method for the motor as claimed in claim 18, wherein the adjustment ratio is between 30% and n*100% wherein n is a positive integer.

24. The activation control method for the motor as claimed in claim 16, wherein the driving unit generates the driving signal based on a control signal generated by a control unit.

25. The activation control method for the motor as claimed in claim 24, wherein the control signal is a pulse signal having a gradually-increasing duty cycle.

26. The activation control method for the motor as claimed in claim 24, wherein the control signal is a pulse signal having a gradually-increasing magnitude.

27. The activation control method for the motor as claimed in claim 24, wherein the control signal is a pulse signal having a gradually-increasing frequency.

28. The activation control method for the motor as claimed in claim 24, wherein the control unit includes an application-specific integrated circuit (ASIC).

29. The activation control method for the motor as claimed in claim 24, wherein the control unit includes a microcontroller unit (MCU) or a digital signal processor (DSP).

30. A fan comprising:
a stator coil configured to be electrified to generate a magnetic force;
a rotor rotatably coupled with the stator coil and including a magnetic member and a plurality of blades, wherein the magnetic member faces the stator coil; and
a driving unit electrically connected to the stator coil and outputting a driving signal to the stator coil, wherein an electrical characteristic value of the driving signal increases in a gradual manner, and wherein the rotor outputs a motive power that is gradually increased during a process the rotor rotates from an electric angle back to a same electric angle.

31. The fan as claimed in claim 30, wherein the electrical characteristic value of the driving signal increases from an initial value to a target value during the process the rotor rotates from the electric angle back to the same electric angle.

32. The fan as claimed in claim 31, wherein the electrical characteristic value of the driving signal is a multiple of a predetermined electrical value and an adjustment ratio.

33. The fan as claimed in claim 32, wherein the adjustment ratio is a characteristic curve with a gradually increasing pattern over time.

34. The fan as claimed in claim 33, wherein the characteristic curve includes a start point and an end point along a time axis, wherein a magnitude of the characteristic curve at the end point is larger than a magnitude of the characteristic curve at the start point.

35. The fan as claimed in claim 34, wherein the characteristic curve is in a linear shape.

36. The fan as claimed in claim 34, wherein the characteristic curve is in a non-linear shape.

37. The fan as claimed in claim 32, wherein the adjustment ratio is between 30% and n*100% wherein n is a positive integer.

38. The fan as claimed in claim 30, wherein the driving unit is electrically connected to a control unit, wherein the control unit outputs a control signal to the driving unit, and wherein the driving unit generates the driving signal based on the control signal.

39. The fan as claimed in claim 38, wherein the control signal is a pulse signal having a gradually-increasing duty cycle.

40. The fan as claimed in claim 38, wherein the control signal is a pulse signal having a gradually-increasing magnitude.

41. The fan as claimed in claim 38, wherein the control signal is a pulse signal having a gradually-increasing frequency.

42. The fan as claimed in claim 38, wherein a measurement unit is electrically connected between the control unit and the driving unit and is adapted to detect an output voltage of the driving unit.

43. The fan as claimed in claim 38, wherein the control unit includes an application-specific integrated circuit (ASIC).

44. The fan as claimed in claim 38, wherein the control unit includes a microcontroller unit (MCU) or a digital signal processor (DSP).
